(19) United States
(12) Patent Application Publication
(10) Pub. No.: US 2013/0015160 A1
(43) Pub. Date: Jan. 17, 2013

(54) RESURFACING AGENT

(71) Applicant: Marcus Smith, Desert Hot Spring, CA (US)

(72) Inventor: Marcus Smith, Desert Hot Spring, CA (US)

(21) Appl. No.: 13/179,972

(22) Filed: Jul. 11, 2011

(51) Int. Cl. B44C 1/22; C09D 7/00

(52) U.S. Cl. 216/83; 106/287.24

(57) ABSTRACT

A plastic, polycarbonate or like material resurfacing or clarifying agent, containing a mixture of acetone and at least one of xylene, toluene, butanone, methyl ethyl ketone, and naphtha is described. The acetone has a weight percentage of about 50% to about 78% of the mixture. The at least one of xylene, toluene, butanone, methyl ethyl ketone, and naphtha has a weight percentage of about 20% to about 45% of the agent. The at least one of xylene, toluene, butatone, methyl ethyl ketone, and naphtha contains one or any combination of toluene, xylene, and MEK with a weight percentage of about 25% of the agent. The agent may further contain isopropyl alcohol. The isopropyl alcohol preferably has a weight percentage of about 1% to about 8% of the agent.

### TECHNICAL FIELD

This disclosure relates to a resurfacing agent, and more particularly, to a resurfacing agent for treating plastic such as polycarbonate of a vehicle headlamp, headlight or other type of light. More broadly, this writing relates to a mixture or solution for clarifying an occluded or damaged surface. The mixture or solution finds application on plastics such as polycarbonate as well as on other materials. Plastics, particularly, polycarbonate is of some interest as these materials are used on vehicle headlight or headlamp covers.

### BACKGROUND

Over time, the surface of a vehicle headlamp can deteriorate. It can become pitted or cracked due to abrasion from road elements such as sand, rocks, dirt and pebbles, as well as due to water and airborne elements. Plastics, such as polycarbonates, used for headlight and headlamp covers can become cloudy and discolored due to oxidation and exposure to ultraviolet light at least from the sun and the headlamp bulb. Deterioration of the plastic can be so extensive that when such materials are used for headlight covers, the headlight light can be significantly dimmed thus requiring replacement of the cover altogether. Further, damage to the headlight covers increases glare from the headlight which is suffered by other road users and reduces visibility for the driver.

Various types of cleaners, clarifiers and polishers have been developed and used for headlight and headlamp covers in an attempt to renew and refresh them. These cleaners and polishes usually include the use of wiping clothes or other means to apply and remove the cleansers and polishes used on the headlight or headlamp covers to restore some of the clearness and transparency of the covers. Sanding or aggressive polishing is commonly used to resurface the covers. These mechanical procedures are labor intensive, time consuming and not highly effective. This type of cleansing also inevitably requires direct and relatively prolonged contact with the chemical solution used to clarify or cleanse the cover by the person applying the clarifying agent. Such direct and prolonged contact could have a toxic effect on the user. Further, the procedure can exacerbate the problematic deterioration of the plastic surface. This is particularly true when the mechanical force applied to the plastic surface to apply and use the cleanser is uneven or excessive.

What is needed is a method and a solution for resurfacing a headlamp cover and like surfaces without the need of a labor-intensive, mechanical procedures. What is further needed is a more effective mechanism to refurbish such surfaces, one as one that may be used quickly and with little physical force and exposure by the user to the cleanser. The embodiments of the present disclosure attempt to respond to these and other needs.

### SUMMARY

In a first embodiment disclosed herein, a polycarbonate resurfacing or clarifying agent comprising a mixture of acetone and at least one of xylene, toluene, MEK (also known as butanone, methyl ethyl ketone), and naphtha (such as VM&P, coal tar, and the like), is provided. The acetone has a weight percentage of about 50% to about 78% of the agent. The at least one of xylene, toluene, MEK, methyl ethyl ketone, and naphtha has a weight percentage of about 20% to about 45% of the agent. Alternatively, the resurfacing or clarifying agent may contain one or any combination of toluene, xylene, and MEK with a weight percentage of about 25% of the agent. The agent may contain methanol preferably with a weight percentage of about 1% to about 8%. The agent may further contain isopropyl alcohol. The isopropyl alcohol preferably has a weight percentage of about 1% to about 8%.

In a second embodiment disclosed herein, a resurfacing or clarifying agent comprising a mixture of a carrying composition and an active composition is provided. The active composition is operative to dissolve, melt, or chemically react with objects on a surface to be treated and the surface in contact with the objects. The carrying composition is operative to carry and vaporize a product created by the objects and the surface dissolved, melted, or chemically reacted with the active composition. The carrying composition preferably includes acetone with a weight percentage preferably no less than about 50% of the agent. Preferably but optionally, the acetone has a weight percentage between about 50% and about 78% of the agent. In some occasions, such as when the resurfacing agent is applied to a surface a second time, the acetone may have a weight percentage of over about 75% or 78% of the agent to facilitate the agent's quick evaporation and therefore effectively, the agent's lighter application to the surface being treated. The active composition includes at least one of xylene, toluene, MEK, methyl ethyl ketone, and naphtha with a weight percentage of about 20% to about 45% of the agent. Alternatively, the active composition may include one or any combination of toluene, xylene, and MEK with a weight percentage of about 25% of the agent, and the active composition includes acetone having a weight percentage of about 75% of the agent. The resurfacing agent also contains methanol preferably with a weight percentage of about 2% to about 16% of the agent. The resurfacing agent further contains isopropyl alcohol. The isopropyl alcohol preferably has a weight percentage of about 1% to about 8% of the agent.

In a third embodiment, a surface treatment method is provided. A resurfacing agent is applied on a surface to be treated to dissolve, melt, or react with the surface portion in contact with the resurfacing agent and to vaporize a product created by the surface portion that reacts with the resurfacing agent. The surface to be treated is positioned generally vertically to the ground and the step of applying the resurfacing agent includes using any suitable method such as pouring or squirting the resurfacing agent from a container along a top row of the generally vertically oriented surface and allowing the resurfacing agent to wash down over all or most of the surface. Preferably, the resurfacing agent is applied to the surface in absence of an external force applied to the surface such as rubbing or wiping the agent on the surface. In fact, such rubbing or wiping of the agent on the surface is usually not advantageous. The method further comprises a step of using a resurfacing or clarifying agent which includes a mixture of acetone and at least one of xylene toluene, MEK, and naphtha. The acetone has a weight percentage of about 50% to about 78% of the agent, and the at least one of xylene toluene, MEK, methyl ethyl ketone, and naphtha has a weight percentage of about 20% to about 45% of the agent. The resurfacing or clarifying agent may further contain methanol and/or isopropyl alcohol. Preferably, the weight percentage for methanol and isopropyl is about 2% to about 16% and about 1% to about 8%, respectively.

These and other features will become further apparent from the detailed description and accompanying figures that follow. In the figures and description, numerals indicate the various features, like numerals referring to like features throughout both the drawings and the description. The terms “headlight” and “headlamp” are used interchangeably. The terms “resurfacing,” “clarifying” and “cleansing” are used interchangeably.

### BRIEF DESCRIPTION OF THE DRAWINGS

FIG. 1 is a schematic drawing showing the resurfacing agent applied to a plastic or polycarbonate lens of a headlamp or headlight in one embodiment.

### DETAILED DESCRIPTION

When a vehicle has been used on the road over a period of time, the brightness of the headlamps or headlights of the vehicle is inevitably decreased due to exposure of the headlight or headlamp to caustic or damaging elements. Dirt, water, contaminants, temperature changes and other elements cause the plastic or polycarbonate lenses covering the headlights to be discolored, scratched, pitted, and damaged. Although there are currently various cleaning agents or solutions developed to be applied to clean and re-surface headlamp covers, almost all of these cleaning agents or resurfacing agents are applied to the headlamp covers through mechanical means, such as wiping clothes, brushes, sand paper, polishing and other scrubbing means. Application of the cleansing agents with these mechanical means is very labor intensive, imprecise and time consuming. This manner of application often causes direct and prolonged contact to the party applying the agents to the harmful chemicals in the agent.

A resurfacing agent, namely, a surface cleaner, a surface remover, surface clarifier or a surface treatment solution, mixture or agent, is described herein to remove the contamination and/or roughness and/or unevenness of the surface of a headlamp without the need of using labor intensive mechanical means or tools to scrub, rub, wipe and abraid the surface. It is to be appreciated that although the resurfacing agent is particularly effective for treating a plastic such as a polycarbonate surface of a headlamp cover, it can also be used to treat other surfaces made of similar material having similar characteristics of plastics such as polycarbonates in all kinds of devices and applications. The resurfacing agent is preferably a liquid solution containing a high weight percentage or volume percentage of a carrying composition and a relatively lower weight percentage or volume percentage of an active composition. The active composition is selected from those which can dissolve and/or chemically react with the contamination that affects plastic and polycarbonate surfaces and react with the plastic or polycarbonate surface itself. The carrying composition serves to remove, dissolve or vaporize the contamination and damage therefrom as well as products created during the resurfacing process. The carrying composition preferably has a low melting point and can be generally non-toxic in either liquid phase or gaseous phase. In one preferred embodiment, the carrying composition includes acetone with about 50% to about 78% weight percentage of the resurfacing agent. The active composition includes xylene with about 20% to about 45% weight percentage. In one embodiment, the resurfacing agent may further contain about 2% to about 16% of methanol and/or about 1% to about 8% weight percentage of isopropyl alcohol. The percentage of each of the compositions is adjustable, depending on the actual material and condition of the surface to be cleaned or treated. In some cases, xylene can be replaced with toluene, MEK, or naphtha. Alternatively, the resurfacing agent can contain a high weight percentage of acetone mixed with one of or any combination of xylene, toluene, and MEK. Preferably but optionally, the weight percentage of the whole of acetone is about 75% and the weight percentage of one or any combination of xylene, toluene, MEK, and naphtha is about 25%.

When the resurfacing agent is placed in contact with the contaminated and/or damaged surface, the contamination on the surface and the damaged part of the surface itself are melted, dissolved or chemically affected by the active composition, that is, the xylene, toluene, MEK, naphtha, or any combination thereof. The resulting product of this chemical reaction is largely carried and vaporized away with the carrying composition, that is, the acetone in one preferred embodiment, within a very short period of time. Because chemical reaction occurs primarily at the portion of the damaged surface in direct contact with the active composition, the thickness of the surface to be removed by this reaction can be controlled by adjusting the amount of the resurface agent applied to that surface. Preferably but optionally, 1 oz (±5% or more) of the resurfacing agent will treat a conventional headlamp or headlight cover with the 1 oz being generally evenly applied over the damaged portion of the headlamp cover. It will be appreciated that the amount can be adjusted according to the actual condition and size of the surface to be treated. For example, when the damage on a surface is moderate, a lesser amount of the resurfacing agent can be applied. On the contrary, when the damage on the surface is serious, additional amounts may be required. In the case where the damage of the headlamp is so serious that the resurfacing agent is not sufficiently effective, preparation such as smoothing or restructuring the surface of the headlamp using steel wool or other kinds of pads can be used on the surface before applying the resurfacing agent. However, as described above, the application of the resurfacing agent itself does not require such mechanical tools and procedures. Also, it is beneficial to cool down the headlamp after the resurfacing agent has been applied. Preferably but optionally, a wind blower or fan can be used to cool down the headlamp. The resurfacing agent is preferably stored at room or lower temperature.

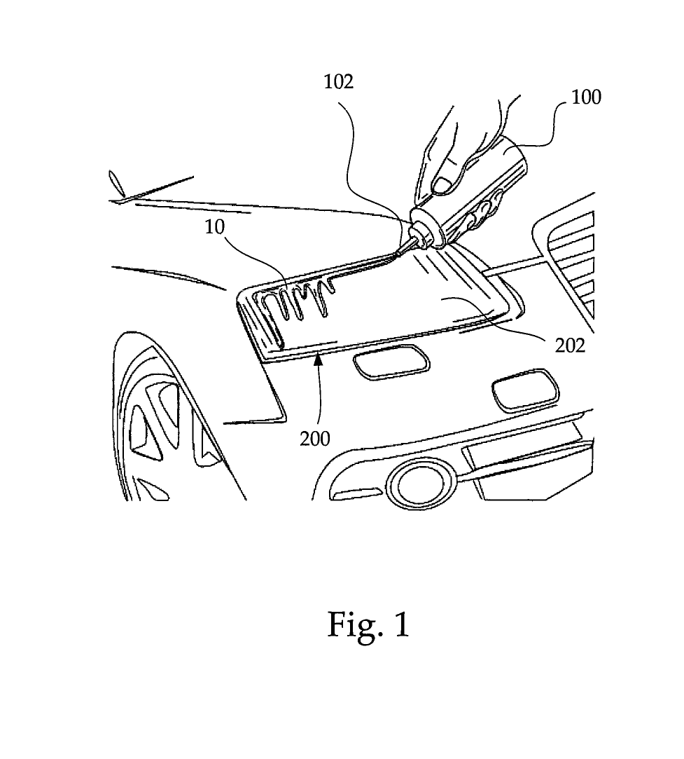

FIG. 1 shows one embodiment of the application of the resurfacing agent 10 to a conventional headlight or headlamp 200. The resurfacing agent 10 is stored in a container 100 made of a material that would not react with any composition of the resurfacing agent 10. Preferably, the container 100 is made of plastic having a relatively high melting point compared to those melting points of the compositions of the resurfacing agent 10. The container 100 is preferably configured in such a way as to store a sufficient amount of the resurfacing agent 10 and to be easily controlled and handled by the user. As 1 oz of the resurfacing agent 10 is typically required to treat a conventional headlamp or headlight cover, the container 100 preferably has a capacity of 1 oz or 2 oz and a shape allowing easy handling and usage. It is appreciated that the capacity, shape, and size of the container are variable, depending on the actual application. The container 100 includes a dispensing tip 102 extending from the main body and sealed by a cap such that the resurfacing agent is prevented from flowing out or vaporizing from the container 100 when it is not in use. The dispensing tip 102 is preferably in the form of a simple opening or formed to enable a fan type spray with a length between about 0.25 inch and about 1 inch. The dispensing tip 102 is configured to allow a desired amount of the resurfacing agent 10 to flow out from the dispensing tip 102 within a specific time period. In other words, the configuration of the dispensing tip 102 is designed to provide a desired flow rate of the resurfacing agent 10 over the surface to be treated as the container is manipulated such as by squeezing it or putting it in a pouring position. Thus, in one embodiment, the container 100 may be made of resilient material such that the user may squeeze the container 100 to force the resurfacing agent 10 to flow or spray out of the container 100, so as to cause or increase the flow rate of the resurfacing agent 10 from the container 100. Alternatively, the dispensing tip 102 may include a valve member to prevent the resurfacing agent 10 from flowing out of the container 102 regardless of how the container 100 is oriented. The valve member may be opened only when an external force is applied to it, such as squeezing the container 100. This way, the user may have control of the flow quantity and rate of flow of the resurfacing agent 10 from the container 100 over the surface 202 to be treated.

To apply the resurfacing agent 10, the cap is removed from the tip 102, and the resurfacing agent 10 flows out from the tip 102 by gravity and/or by spraying when the tip 102 is pointed downwardly and/or toward a top area of a plastic or polycarbonate surface 202 of the headlamp 200. Alternatively, the resurfacing agent 10 may be squeezed, squirted or retrieved by other forms of force from the container 100 by the user. To allow the resurfacing agent 10 to be distributed generally evenly over the polycarbonate or plastic surface 202 of the headlamp, the resurfacing agent 10 is promptly and evenly applied along a top row or area of the surface 202 of the headlamp 200 to facilitate a generally even application of the solution on surface 202. Gravity causes the resurfacing agent 10 to wash down and over surface 202. The resurfacing agent 10 may also be applied to other places of the surface 202 depending on actual need. Also, depending on the actual size or the damage level of the surface to be treated, the resurfacing agent 10 may be applied to the top row of the surface or other desired location of the surface once to several times. The resurfacing agent 10 may be applied to a row lower than the top row in the first or subsequent time of application if greater resurfacing is needed in a specific area.

As disclosed above, the active composition of the resurfacing agent 10 is selected from the chemicals, such as xylene or its substitute, toluene, MEK, or naphtha, to melt, dissolve or create a chemical reaction with the contamination and the surface 202 of the headlamp 200. The product created by the chemical reaction is then largely carried and vaporized away from the surface 202 of the headlamp 200 with the foregoing flow treatment and evaporation. Therefore, the conventional mechanical process or procedure of cleaning, clarifying and resurfacing a headlight cover, such as by wiping, sanding, polishing and abrading the surface with a resurfacing agent is not necessary. To ensure that the product of the chemical reaction or any residue is removed from the surface of the headlamp 200, the user can simply apply alcohol to allow further vaporization of the residue. Again, no mechanical rubbing, wiping, buffing, or polishing with the solution is required.

The resurfacing agent 10 described above is preferably used to resurface a headlamp only once. In certain situations, when a second resurfacing process is required, the weight percentage of the carrying composition is preferably adjusted. That is, acetone with a weight percentage of over 75% to 78% of the agent is preferred to avoid excessive removal of the headlamp surface.

Having now described the invention, obvious modifications will be apparent to those skilled in the art. Such changes and modifications may be made without departing from the scope of the invention as disclosed and claimed.

The foregoing Detailed Description of exemplary and preferred embodiments is presented for purposes of illustration only. This description is not intended to be exhaustive nor to limit the invention to the precise form(s) here described. Rather, it is to enable others skilled in the art to understand how the invention may be suited for a particular use or purpose. The possibility of modifications and variations will be apparent to practitioners skilled in the art. It is intended that the scope of the invention be defined by the claims as written and equivalents thereof as applicable. Reference to a claim element in the singular is not intended to mean “one and only one” unless explicitly so stated. Moreover, no element, component, method or process step in this disclosure is intended to be dedicated to the public regardless of whether the element, component, or step is explicitly recited in the claims. No claim element is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “comprising the step(s) of . . . .”

All percentages presented may vary by plus or minus five percent.

Broadly, this writing has disclosed at least the following:

a plastic such as polycarbonate or like material resurfacing or clarifying agent, containing a mixture of acetone and at least one of xylene, toluene, butanone, methyl ethyl ketone, and naphtha. The acetone has a weight percentage of about 50% to about 78% of the agent. The at least one of xylene, toluene, butanone, methyl ethyl ketone, and naphtha has a weight percentage of about 20% to about 45% of the agent. The at least one of xylene, toluene, butatone, methyl ethyl ketone, and naphtha contains one or any combination of toluene, xylene, and MEK with a weight percentage of about 25% of the agent. The agent may further contain methanol and/or isopropyl alcohol. The methanol and isopropyl alcohol preferably have weight percentages of about 2% to about 16% and about 1% to about 8% of the agent, respectively.

### CONCEPTS

As short summaries, this writing has disclosed at least the following broad concepts.

CONCEPT 1. A polycarbonate treatment mixture, comprising a mixture of acetone and at least one of xylene, toluene, MEK (methyl ethyl ketone, butanone), and naphtha, wherein the acetone has a weight percentage of about 50% to about 78% of the mixture.
CONCEPT 2. The treatment mixture of concept 1, wherein the at least one of xylene, toluene, MEK, and naphtha has a weight percentage of about 20% to about 45% of the mixture.
CONCEPT 3. The treatment mixture of concept 1, wherein the at least one of xylene, toluene, MEK, and naphtha includes one or any combination of toluene, xylene, and MEK with a weight percentage of about 25%, the acetone having a weight percentage of about 75% of the mixture.
CONCEPT 4. The treatment mixture of concept 1, wherein the mixture further contains at least one of methanol and isopropyl alcohol.
CONCEPT 5. The treatment mixture of concept 3, wherein the methanol has a weight percentage of about 2% to about 16%, and the isopropyl alcohol has a weight percentage of about 1% to about 8% of the mixture.
CONCEPT 6. The treatment mixture of concept 1, consisting of acetone and at least one of xylene, toluene, MEK, and naphtha.
CONCEPT 7. The treatment mixture of concept 1, consisting of acetone, at least one of xylene, toluene, MEK, and naphtha, methanol, and isopropyl.
CONCEPT 8. A resurfacing solution comprising a mixture of a carrying composition and an active composition, wherein the active composition is operative to dissolve or chemically react with objects on a surface and the surface in contact therewith, and the carrying composition is operative to carry and vaporize a product created by the objects and the surface dissolved or chemically reacted with the active composition.
CONCEPT 9. The resurfacing solution of concept 8, wherein the carrying composition includes acetone with a weight percentage no less than about 50% of the mixture.
CONCEPT 10. The resurfacing solution of concept 9, wherein the acetone has a weight percentage between about 50% and about 78% of the mixture.
CONCEPT 11. The resurfacing solution of concept 9, wherein the acetone has a weight percentage over about 78% of mixture for application to a treated surface a second time.
CONCEPT 12. The resurfacing solution of concept 8, wherein the active composition includes at least one of xylene, toluene, MEK, and naphtha.
CONCEPT 13. The resurfacing solution of concept 12, wherein the at least one of xylene, toluene, MEK, and naphtha has a weight percentage of about 20% to about 45% of the mixture.
CONCEPT 14. The resurfacing solution of concept 8, wherein the active composition includes one or any combination of toluene, xylene, MEK, and naphtha with a weight percentage of about 25% of the mixture, and the active composition includes acetone has a weight percentage of about 75% of the mixture.
CONCEPT 15. The resurfacing solution of concept 8, wherein the resurfacing solution further contains at least one of methanol and isopropyl alcohol.
CONCEPT 16. The resurfacing solution of concept 15, wherein the methanol has a weight percentage of about 2% to about 16%, and the isopropyl alcohol has a weight percentage of about 1% to about 8% of the mixture.
CONCEPT 17. A surface treatment method, comprising the steps of: applying a resurfacing agent on a surface to be treated to:

allowing the resurfacing agent to dissolve or chemically react with the surface portion in contact with the resurfacing agent; and
allowing the resurfacing agent to vaporize product created allowing the resurfacing agent to dissolve or chemically react with the surface portion in contact with the resurfacing agent.
   CONCEPT 18. The method of concept 17, wherein the surface to be treated is positioned in a generally vertical position and the step of applying the resurfacing agent includes pouring or squirting the resurfacing agent from a container along a top row of the surface and allowing the resurfacing agent to wash down over the surface to be treated.
   CONCEPT 19. The method of concept 17, further comprising the step of applying the resurfacing agent to the surface in absence of a least one of rubbing, wiping, scrubbing and polishing the surface with the resurfacing agent.
   CONCEPT 20. The method of concept 17, further comprising providing the resurfacing agent having a mixture of acetone and at least one of xylene toluene, MEK, and naphtha.
   CONCEPT 21. The method of concept 20, wherein the acetone has a weight percentage of about 50% to about 78% of the agent, and the at least one of xylene toluene, MEK, and naphtha has a weight percentage of about 20% to about 45% of the agent.
   CONCEPT 22. The method of concept 20, wherein the resurfacing agent further contains at least one of methanol and isopropyl alcohol.

What is claimed is:

1. A polycarbonate treatment mixture, comprising a mixture of acetone and at least one of xylene, toluene, MEK (methyl ethyl ketone, butanone), and naphtha, wherein the acetone has a weight percentage of about 50% to about 78% of the mixture.

2. The treatment mixture of claim 1, wherein the at least one of xylene, toluene, MEK, and naphtha has a weight percentage of about 20% to about 45% of the mixture.

3. The treatment mixture of claim 1, wherein the at least one of xylene, toluene, MEK, and naphtha includes one or any combination of toluene, xylene, and MEK with a weight percentage of about 25%, the acetone having a weight percentage of about 75% of the mixture.

4. The treatment mixture of claim 1, wherein the mixture further contains at least one of methanol and isopropyl alcohol.

5. The treatment mixture of claim 3, wherein the methanol has a weight percentage of about 2% to about 16%, and the isopropyl alcohol has a weight percentage of about 1% to about 8% of the mixture.

6. The treatment mixture of claim 1, consisting of acetone and at least one of xylene, toluene, MEK, and naphtha.

7. The treatment mixture of claim 1, consisting of acetone, at least one of xylene, toluene, MEK, and naphtha, methanol, and isopropyl.

8. A resurfacing solution comprising a mixture of a carrying composition and an active composition, wherein the active composition is operative to dissolve or chemically react with objects on a surface and the surface in contact therewith, and the carrying composition is operative to carry and vaporize a product created by the objects and the surface dissolved or chemically reacted with the active composition.

9. The resurfacing solution of claim 8, wherein the carrying composition includes acetone with a weight percentage no less than about 50% of the mixture.

10. The resurfacing solution of claim 9, wherein the acetone has a weight percentage between about 50% and about 78% of the mixture.

11. The resurfacing solution of claim 9, wherein the acetone has a weight percentage over about 78% of mixture for application to a treated surface a second time.

12. The resurfacing solution of claim 8, wherein the active composition includes at least one of xylene, toluene, MEK, and naphtha.

13. The resurfacing solution of claim 12, wherein the at least one of xylene, toluene, MEK, and naphtha has a weight percentage of about 20% to about 45% of the mixture.

14. The resurfacing solution of claim 8, wherein the active composition includes one or any combination of toluene, xylene, MEK, and naphtha with a weight percentage of about 25% of the mixture, and the active composition includes acetone has a weight percentage of about 75% of the mixture.

15. The resurfacing solution of claim 8, wherein the resurfacing solution further contains at least one of methanol and isopropyl alcohol.

16. The resurfacing solution of claim 15, wherein the methanol has a weight percentage of about 2% to about 16%, and the isopropyl alcohol has a weight percentage of about 1% to about 8% of the mixture.

17. A surface treatment method, comprising the steps of:
applying a resurfacing agent on a surface to be treated to:
allowing the resurfacing agent to dissolve or chemically react with the surface portion in contact with the resurfacing agent; and
allowing the resurfacing agent to vaporize product created allowing the resurfacing agent to dissolve or chemically react with the surface portion in contact with the resurfacing agent.

18. The method of claim 17, wherein the surface to be treated is positioned in a generally vertical position and the step of applying the resurfacing agent includes pouring or squirting the resurfacing agent from a container along a top row of the surface and allowing the resurfacing agent to wash down over the surface to be treated.

19. The method of claim 17, further comprising the step of applying the resurfacing agent to the surface in absence of a least one of rubbing, wiping, scrubbing and polishing the surface with the resurfacing agent.

20. The method of claim 17, further comprising providing the resurfacing agent having a mixture of acetone and at least one of xylene toluene, MEK, and naphtha.

21. The method of claim 20, wherein the acetone has a weight percentage of about 50% to about 78% of the agent, and the at least one of xylene toluene, MEK, and naphtha has a weight percentage of about 20% to about 45% of the agent.

22. The method of claim 20, wherein the resurfacing agent further contains at least one of methanol and isopropyl alcohol.
